(19) United States
(12) Patent Application Publication
(10) Pub. No.: US 2026/0253360 A1
(43) Pub. Date: Aug. 27, 2026

(54) Merging of Partial Images of Vehicle Surroundings

(71) Applicant: BAYERISCHE MOTOREN WERKE AKTIENGESELLSCHAFT, Muenchen (DE)

(72) Inventor: Philipp HOFFMANN, Hannover (DE)

(21) Appl. No.: 18/994,192

(22) PCT Filed: Jun. 26, 2023
(86) PCT No.: PCT/EP2023/067344

§ 371 Date: Jan. 14, 2025

(30) Foreign Application Priority Data
Sep. 29, 2022 (DE) 10 2022 125 210.8

(51) Int. Cl. G06V 10/10; G06T 3/4038; G06T 7/50; G06V 20/58

(52) U.S. Cl. CPC G06V 10/16; G06T 3/4038; G06T 7/50; G06V 20/58; G06T 2207/20221; G06T 2207/30196; G06T 2207/30252; G06V 2201/08

(57) ABSTRACT

The disclosure relates to a method for merging partial images of surroundings of a vehicle to form a whole image. The method includes capturing a first partial image in a first region of the surroundings, the first region being laterally behind the vehicle; capturing a second partial image in a second region of the surroundings, the second region being behind the vehicle; detecting an object, at least one section of which is in one of the regions; determining a distance between the object and the vehicle; adjusting the second partial image depending on the distance; and merging the partial images to form a whole image.

### BACKGROUND AND SUMMARY

The present disclosure relates to the merging of partial images from vehicle surroundings. In particular, the disclosure relates to merging partial images which are produced from different positions and/or with different fields of view.

A vehicle, in particular a motor vehicle, comprises a camera-monitor system (CMS) configured to replace a conventional exterior mirror. For this purpose, the CMS comprises a camera attached laterally to the vehicle, the field of view of which opens up counter to the direction of travel of the vehicle. An image provided by the camera can be displayed in the interior of the vehicle on a monitor. The monitor lies in the area of a visual axis of a driver to the camera. The CMS can additionally comprise a processing device in order to process an image provided by the camera, for example with respect to an image detail, a brightness, or a contrast.

An area located directly behind the vehicle cannot be seen by the camera. It has been proposed that a further camera be provided on the rear of the vehicle and the images of the two cameras be combined in such a way that an overall image results. The overall image can have two different sections horizontally offset, which originate from the different cameras. There can be a joining line between the two sections. The merging (“stitching”) is carried out in such a way that no optical errors result in the area of the joining line. In particular, an object which extends over the joining line on the overall image is to be displayed as completely and as free of interference as possible.

DE 10 2014 213 536 A1 proposes a driver assistance system for merging partial images to form an overall image from a contiguous surrounding area of a vehicle.

DE 10 2017 217 870 A1 describes a similar method, in which a joining line between a first and a second section of the overall image is determined based on a signal of a sensor arrangement.

Since the cameras have different optical perspectives, the merging or the selection of a matching section of one of the images of the camera can be subjected to different requirements if the object is located at different distances.

Previous technologies could not always reliably prevent an object located behind the vehicle from being completely displayed, in particular if the object moves in relation to the vehicle. One object underlying the disclosure is to specify an improved technology for merging partial images of the surroundings of a vehicle to form an overall image with respect to an object that overlaps both partial images.

According to a first aspect of the present disclosure, a method for merging partial images of the surroundings of a vehicle to form an overall image comprises steps of acquiring a first partial image in a first area of the surroundings, wherein the first area is located laterally behind the vehicle; acquiring a second partial image in a second area of the surroundings, wherein the second area is located behind the vehicle, acquiring an object, at least one section of which is located in one of the areas; determining a distance of the object from the vehicle; adapting the second partial image depending on the distance; and merging the partial images to form the overall image.

The first area can be scanned, for example, by a side camera which is attached laterally to the vehicle and is oriented to the rear. The first area corresponds to the area which can be seen by a conventional exterior mirror. The second area can be scanned by a rear camera, which is attached centrally or laterally, on the same side as the side camera, to the vehicle and is oriented directly to the rear. The second area can be similar to an area which can be seen by a typical interior mirror, but has a viewpoint offset to the rear and is not restricted by a rear window.

Adapting the second partial image can in particular comprise scaling. The scaling can furthermore be carried out homographically, wherein line-faithful mapping can be carried out, in particular collineation. The object is located at least in some sections in the second area. If the object should move laterally with respect to the vehicle, it can enter the first area. No optical abnormality can be noticeable in the overall image here due to the early adaptation of the second partial image.

Since only one of the partial images is dynamically adapted, the method can be less susceptible to interference. A provided overall image can appear calmer overall and can be subjected to less frequent changes. In particular, it is possible to prevent the object from being partially or completely lost upon the merging of the partial images, so that it does not appear or does not completely appear on the overall image. A person who uses the overall image to assess a traffic situation in the area of the vehicle, in particular a driver on board the vehicle, can be informed in an improved manner by the overall image. Overlooking the object can be less probable. A collision with the object can therefore be avoided in an improved manner.

The object can in particular comprise another road user, for example a motor vehicle, a bicyclist, or a pedestrian. The road user can be stationary, can move in the same direction or a different direction than the vehicle, or can also move laterally in relation to the vehicle. The object can also comprise another installation, for example a traffic sign, a park bench, or a building. Such installations can in particular represent potential collision partners during reverse driving of the vehicle, for example when entering or leaving a parking space. The risk of a collision can be avoided in an improved manner by the improved representation thereof on the overall image.

In one or more embodiments, the adaptation only takes place when the object is depicted in both partial images or when it is located in both areas. A transition area can be formed at a transition between the first and the second partial image, which follows the joining line but has a predetermined horizontal extension. For example, the transition area can be approximately 50 pixels wide on the left and the right of the joining line. The adaptation can take place if the object extends beyond a left or right boundary of the transition area. A front or rear boundary with respect to the movement of the object can be evaluated here.

It is preferred for the overall image to comprise a first section, which is taken from the first partial image and represents an area of the surroundings outside the vehicle; and a second section, which is taken from the second partial image and represents an area of the surroundings located behind the vehicle.

Sensors for providing the partial images can be attached at different positions in the longitudinal direction of the vehicle, so that they can have different distances to the object. In addition, image angles of the sensors can be different, so that the non-adapted partial images can represent the same object in different sizes.

It is preferred for a joining line which delimits the first section on the overall image to be permanently predetermined based on perspectives and imaging parameters of the partial images. A perspective can be dependent on a position of an assigned sensor with respect to the vehicle. An imaging parameter can in particular comprise an image angle or a focal length of the sensor.

The joining line can extend between the first and the second section. Optionally, the joining line is represented or optically highlighted in the overall image. The joining line can follow a contour of the vehicle on the first partial image. The course of the joining line on the overall image can be predetermined and unchanging. The second partial image is adapted such that a section of the object located in the area of the joining line appears equal in size in the first partial image and in the adapted second partial image.

Furthermore, the overall image comprises a third section, which conceals an area located between the vehicle and the object if a further object is located in this area. The third section can be comprised by the second section. In particular, the third area is apparently located below the object in the second section to an observer of the overall image. If no further object is located in this area, an optical error between the third section and an area located beyond the joining line can be accepted. However, if a further object is located between the vehicle and the object, its representation can be omitted to avoid an image error in this area. A driver can be informed in an improved manner about the object without having to assess a further object possibly displayed with interference in the overall image.

The further object can move in relation to the vehicle independently of the other object. If the further object enters the area between the vehicle and the object, the third section can be softly hidden with a predetermined transition. An observer of the overall image can thus be confused or alarmed less.

In one or more embodiments, the third section is taken from the first partial image and shows the vehicle. In other words, an area located behind the vehicle can be inserted into the second section in such a way that the impression results for an observer of the overall image as if the vehicle were transparent. A corresponding part of the vehicle can be displayed as opaque again to conceal the third section. In one or more embodiments, a predetermined image can also be displayed instead of the vehicle. An observer can be notified by the image that a recognized object in this area is intentionally not displayed.

In a corresponding manner, the overall image can comprise a fourth section, which conceals an area apparently located above the object. The fourth section can be filled up like the third section as needed with a predetermined image or a section of the first partial image in order to avoid the display of an image error in this area.

It is furthermore preferred for adaptations of the second partial image to be predetermined for multiple predetermined distances between the vehicle and the object. For example, the distances can each comprise a multiple of approximately 5 m. In one or more embodiments, approximately 11 distances are provided. A shortest distance can be in the range of approximately 1 to 2 m. A distance which is farthest away can be in the range of approximately 47 to 50 m. It has been shown that many display tasks can be satisfactorily solved by a single-digit or low double-digit number of predetermined distances, without having to generate an adaptation dynamically. In one or more embodiments, an adaptation to be used, the assigned distance of which is closest to the determined distance. Alternatively, an adaptation can also be used for a determined distance, the assigned distance of which is the next shorter or the next longer one.

In one or more embodiments, with respect to a first predetermined adaptation, the assigned distance of which is less than the determined distance, and a second predetermined adaptation, the assigned distance of which is greater than the determined distance, an adaptation is interpolated and applied to the second partial image. The interpolation can be carried out with respect to one or more parameters of an adaptation. In one or more embodiments, an adaptation is determined by a scaling factor. In one or more embodiments, it can also comprise a shift in the horizontal and/or vertical direction as a parameter. Further parameters are also possible. Optionally, an extrapolation of the adaptations can also take place if the distance of the object is outside the range in which predetermined adaptations are known.

The method can take into consideration that multiple objects are located in the surroundings of the vehicle. An object can be located at least in some sections in the first and/or in the second area.

In one or more embodiments, of multiple objects in the surroundings of the vehicle, one is selected, the distance of which to the vehicle is least. The object located closest to the vehicle can be most relevant for the guidance of the vehicle.

In one or more embodiments, of multiple objects in the surroundings of the vehicle, one is selected, the expected time of which until reaching the vehicle is least. An object can thus in particular be determined as relevant when it approaches the vehicle rather than another one, the distance of which to the vehicle remains the same or increases.

In one or more embodiments, of multiple objects in the surroundings of the vehicle, one is selected which is most sensitive with respect to a collision with the vehicle. In other words, an object can be selected, the collision of which with the vehicle results in the greatest damage to be expected. A pedestrian can thus be classified as more sensitive than a bicyclist, this bicyclist as more sensitive than a motorcycle, the motorcycle as more sensitive than an automobile, and this automobile as more sensitive than a truck.

It is to be noted that the mentioned strategies for selecting one of multiple objects in the surroundings of the vehicle can also be combined with one another. For example, initially only one of the approaches can be used, as long as it only determines one object. If more than one object is determined as equivalent by the selected approach, a second predetermined approach can be used in order to select one object among these. Optionally, still a further approach can also be added downstream.

It is furthermore to be noted that the technology described herein is intended for improved display of combined partial images to a driver of the vehicle and not for a control of the vehicle, which under certain circumstances bases the determination of the most relevant object on other criteria. However, common sensors or scanning systems can be used for both systems. Preprocessing of a provided partial image, for example by generating a frame around an object, can also be carried out for both systems.

A first sensor for providing the first partial image can be calibrated based on a feature of the vehicle that can be optically acquired in the first area. In other words, an orientation of the first sensor with respect to the vehicle or the surroundings can be checked and corrected if necessary by checking the location of the feature in the provided partial image. It can thus be ensured that the first section of the overall image taken from the first partial image is correctly positioned in an improved manner.

A second sensor for providing the second partial image can be calibrated by an orientation sensor. The orientation sensor can indicate the orientation of the second sensor in relation to the vehicle or the surroundings. A gyroscope or an inertial platform can be used for this purpose. A drift of the orientation sensor can be corrected with respect to the first partial image.

According to a second aspect of the present disclosure, a device for merging partial images of the surroundings of a vehicle to form an overall image comprises the following elements: a first sensor for acquiring a first partial image in a first area of the surroundings, wherein the first area is located laterally behind the vehicle; a second sensor for acquiring a second partial image in a second area of the surroundings, wherein the second area is located behind the vehicle; a third sensor for determining a distance of an object, at least one section of which is located in the first and in the second area, from the vehicle; and a processing device. The processing device is configured here to adapt the second partial image depending on the distance and to merge the partial images to form the overall image.

The processing device can be configured to entirely or partially carry out a method described herein. For this purpose, the processing device can be embodied electronically and can comprise, for example, a programmable microcomputer or microcontroller and the method can be provided in the form of a computer program product having program code. The computer program product can also be stored on a computer-readable data carrier. Features or advantages of the method can be transferred to the device or vice versa.

The first sensor can in particular comprise a side camera, which is attached in an area in which otherwise a conventional exterior mirror is attached. The second sensor can comprise a rear camera, which is attached to a rear end of the vehicle. The rear camera can be attached centrally or laterally offset on the vehicle, in the direction of the side camera. The third sensor can comprise, for example, a radar sensor, a LiDAR sensor, or an ultrasonic sensor. The third sensor is also attached in the area of the rear of the vehicle. Positions of the sensors on the vehicle and image angles of the first and second sensors are predetermined and unchanging.

In one or more embodiments, an orientation sensor for determining an orientation of the second sensor in relation to the surroundings is provided. The orientation sensor can provide a signal that corresponds to the orientation of the second sensor. The second partial image provided by it can thus be adapted in an improved manner in order to be in the correct location with respect to the first partial image.

According to still a further aspect of the present disclosure, a vehicle comprises a device described herein.

The disclosure will now be described in more detail with reference to the appended drawings.

### BRIEF DESCRIPTION OF THE DRAWINGS

FIG. 1 illustrates a device on board a vehicle;

FIG. 2 illustrates a flow chart of a method;

FIG. 3 illustrates an overall image merged from a first partial image and a second partial image in one or more embodiments;

FIG. 4 illustrates an overall image merged from a first partial image and a second partial image in one or more embodiments;

FIG. 5 illustrates a schematic relationship between a distance and a scaling factor.

### DETAILED DESCRIPTION OF THE DRAWINGS

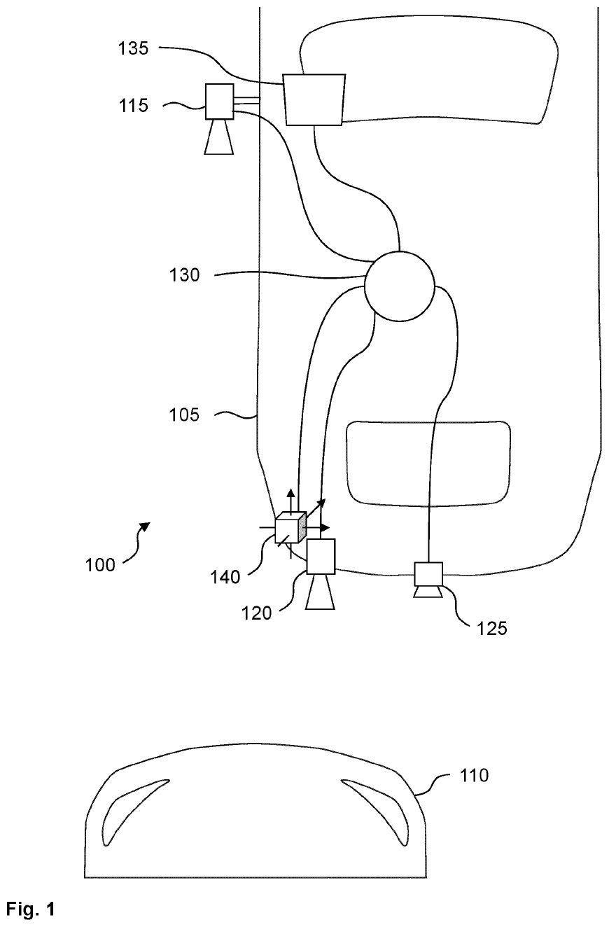

FIG. 1 shows a device 100 on board a vehicle 105. The vehicle 105 comprises a motor vehicle, in particular a motorcycle, a passenger vehicle, a truck, or a bus. A direction of travel of the vehicle 105 extends from bottom to top in the illustration of FIG. 1. An object 110, which is shown by way of example as a further vehicle, is located behind the vehicle 105. The device 100 comprises a first camera 115, a second camera 120, a distance sensor 125, and a processing device 130. The first camera 115 is attached laterally on the vehicle 105 and is configured to scan an area located laterally to and behind the vehicle 105. The second camera 120 is attached in an area of the rear of the vehicle 105 and is configured to scan an area located behind the vehicle 105. It is preferred here for the two areas to overlap. The distance sensor 125 is also attached on the rear of the vehicle 105.

The processing device 130 is configured to merge a first partial image provided by the first camera 115 and a second partial image provided by the second camera 120 to form an overall image. In one or more embodiments, a monitor 135 is provided to display the overall image on board the vehicle 105. The device 100 can operate in this sense as a camera-monitor system.

Optionally, an orientation sensor 140 is provided in the area of the second camera 120 in order to determine an orientation of the second camera 120. The processing device 130 is configured to detect a deviation of the orientation of the second camera 120 in relation to a predetermined orientation based on signals of the orientation sensor 140 and optionally to compensate for it. For this purpose, the orientation of the second camera 120 can be changed by a corresponding actuator or the provided second partial image can be shifted appropriately.

The processing device 130 can also check an orientation of the first camera 115 in relation to the vehicle 105, for example in that the location of an optically recognizable feature of the vehicle 105 in the first partial image is compared to a predetermined location. A compensation by actuator or by adaptation of the first partial image can also optionally take place here.

It is to be noted that two devices 100 can be used on the vehicle 105, which are optionally embodied as partially integrated with one another. In one or more embodiments, the first camera 115, the second camera 120, the monitor 135, and the orientation sensor 140 are located on the left side of the vehicle 105. Corresponding elements can also be provided on the right side of the vehicle 105. For example, the processing device 130 and/or the distance sensor 125 can be usable for both sides.

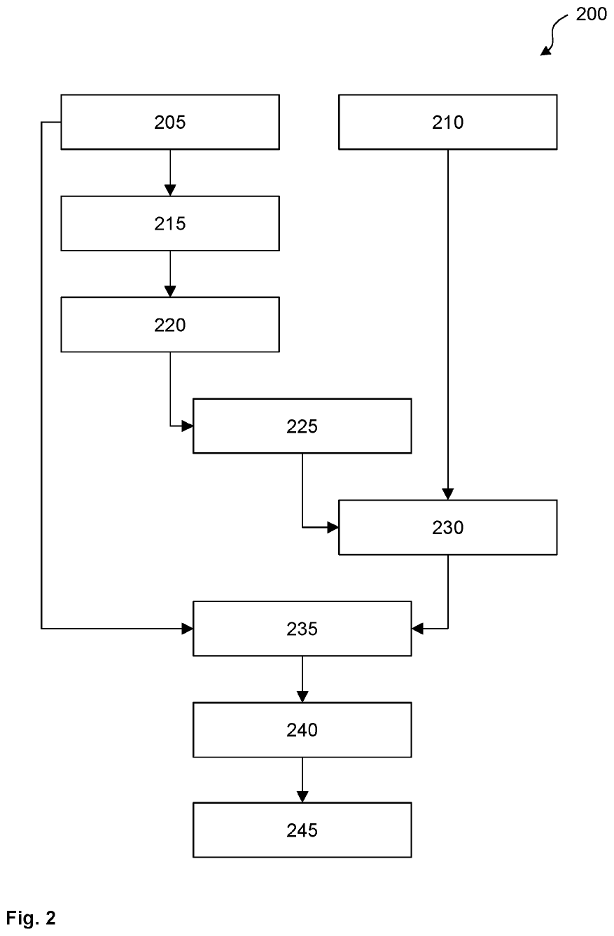

FIG. 2 shows a flow chart of a method 200 for merging partial images. The method 200 can be carried out in particular by a device 100.

In a step 205, a first area of the surroundings of the vehicle 105 can be scanned by the first camera 115 and a first partial image can be created. In a corresponding manner, in a step 210, a second area of the surroundings of the vehicle 105 can be scanned by the second camera 120 and a second partial image can be created. It is preferred for the areas to overlap so that an object can be visible both in the first and in the second partial image.

In a step 215, one or more objects 110 in the surroundings of the vehicle 105 can be recognized. The recognition takes place based on the first partial image, but in one or more embodiments can also be carried out based on the second partial image or scanning of the surroundings by the distance sensor 125.

If multiple objects 110 were determined in step 215, one of them can be selected in a step 220. For this purpose, it can be determined in particular which of the objects 110 is most relevant for the guidance or the movement of the vehicle 105. In one or more embodiments, the object 110 can be selected, the distance of which to the vehicle 105 is least. In one or more embodiments, the object 110 can be selected, the expected time of which until reaching the vehicle 105 is least. This determination can require the calculation of relative speeds between various objects 110 and the vehicle 105. An object 110 which is remote from the vehicle 105 can be discarded as not relevant. In one or more embodiments, that object can be selected which is most sensitive with respect to a collision with the vehicle 105. For this purpose, the object can be classified and classes of different determined objects 110 can be compared to one another.

In a step 225, a distance between the vehicle 105 and the selected object 110 can be determined. For this purpose, a scan of the surroundings by the distance sensor 125 can be used. The distance sensor 125 can determine distances of multiple objects 110 in the surroundings of the vehicle 105 at the same time.

Depending on the determined distance, in a step 230, the second partial image provided in step 210 can be adapted. In particular, a size of the second partial image can be adapted depending on the determined distance.

A number of adaptations is predetermined, to which different distances to the vehicle 105 are assigned. In one or more embodiments, adaptations are provided for distances of 2 m, 3 m, 5 m, 7 m, 12 m, 17 m, 22 m, 27 m, 32 m, 37 m, and 47 m. Each adaptation comprises a scaling factor by which the second partial image can be increased or reduced in size. Further possible parameters comprise a focal point for the scaling, a shift in the horizontal and/or vertical direction, a rotation, or a distortion correction.

A predetermined adaptation can be selected based on the determined distance. Alternatively, an adaptation can be interpolated with respect to two or more predetermined adaptations. The adaptation can be applied to the second partial image, so that the second partial image has the same magnification as the first partial image at the distance which the selected object 110 has.

In a step 235, the first partial image and the second partial image can be merged. The merging takes place with respect to a predetermined joining line, which can be formed by a silhouette of the vehicle 105 on the first partial image.

In an optional step 240, an area of the overall image can be hidden, which is taken from the second partial image and is located below or above the displayed object 110. The area located underneath can in particular be hidden if a further object is located therein. The area located above can also be hidden in particular if a further object is located therein. The hiding can comprise the corresponding area on the overall image being filled by content taken from the first partial image. Alternatively, a predetermined representation can also be inserted, for example a predetermined signal color or a predetermined pattern.

In a step 245, the determined overall image can be displayed, in particular on the monitor 135.

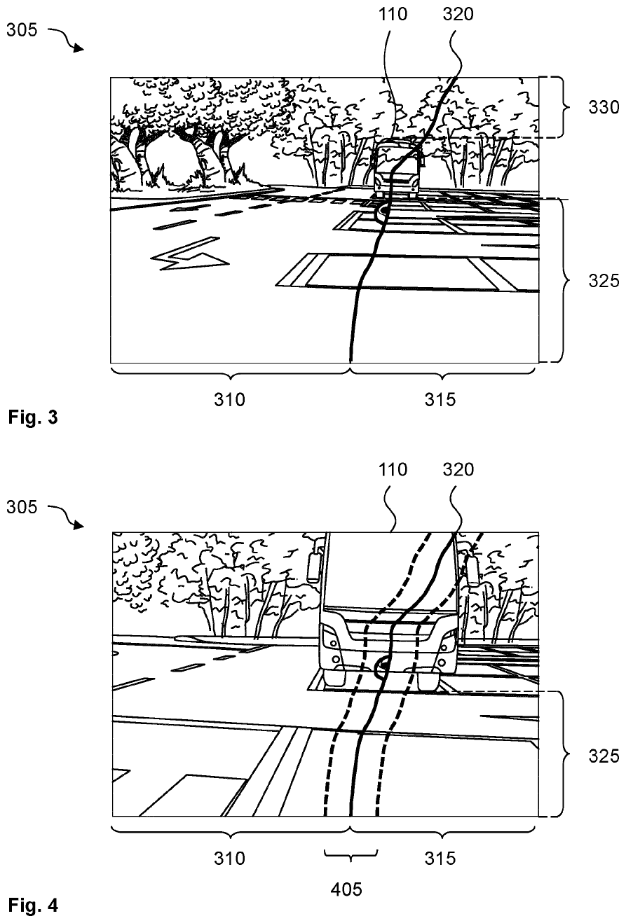

FIG. 3 shows an overall image 305, which comprises a first section 310 taken from a first partial image and a second section 315 taken from a second partial image. A joining line 320, which has the shape of a silhouette of the vehicle 105 in the first partial image, extends between the sections 310 and 315. The joining line 320 extends along a boundary of the vehicle 105. In a vertical middle area, a doorhandle of the vehicle 105 is recognizable in the joining line 320.

A part of the surroundings of the vehicle 105, which cannot be seen through the vehicle 105 in the first partial image, is supplemented in the overall image 305 by a corresponding detail of the second partial image. For this purpose, the second partial image is scaled and in particular magnified depending on the distance of the object 110 from the vehicle 105.

The overall image 305 comprises a third section 325 and a fourth section 330, each of which forms a section of the second section 315. The third section 325 is located below the representation of the object 110 in the second section 315 and the fourth area 330 is located above the representation.

The object 110 is displayed accurately in size in both sections 310, 315 in the overall image. The representation is accurate to the lines, so that a straight line which extends over both sections 305, 310 does not experience unsteadiness or a direction change.

The merging can be adapted depending on the distance to this object 110. Otherwise, if no further object 110 is present or an existing object 110 was not determined as more relevant than the other object 110, the third section 325 can be hidden. For example, a matching section of the vehicle 105 or a predetermined graphic can be displayed in the third section 325. The predetermined graphic can be optically striking to indicate that the third section 325 does not comprise a depiction of an area located behind the vehicle 105.

In a similar manner, the fourth section 330 can be hidden or covered by another representation if a further object 110, which is in particular at least partially located in the second section 315, is located in an area which is located above or behind the object 110 from the displayed perspective. Only an object 110 relevant for the guidance of the vehicle 105 can also be taken into consideration here.

It can be seen that an image error along the joining line 320 in the area of the fourth section 330 is minor if the object, a tree by way of example in FIG. 3, is located at a substantially greater distance to the vehicle 105 than the object 110, which is used for the adaptation. Therefore, hiding the fourth section 330 can also be dispensed with.

FIG. 4 shows an overall image 305 in the manner of the representation of FIG. 3 under different conditions. The distance between the vehicle 105 and the object 110 is less and the object 110 appears to be larger in the overall image 305 here. The third section 325 is smaller than in the representation of FIG. 3 and the fourth section 330 is omitted. Image contents which display the object 110 also adjoin one another with high accuracy on different sides of the joining line 320. Image contents which occupy a different distance to the vehicle 105 than the object 110 cannot smoothly adjoin one another at the joining line 320, however, or have a bend in the area of the joining line 320.

An exemplary transition area 405 is shown by interrupted lines in FIG. 4. The transition area 405 has the course of the joining line 320 in the vertical direction by way of example and a predetermined horizontal width. The joining line 320 is located horizontally in the center of the transition area 405, so that a left boundary is at the same distance from the joining line 320 as a right boundary.

The adaptation of the second partial image can only take place when an object 110 touches or passes over a left and/or right boundary of the transition area 405. An object 110 on the first or second partial image can be provided with a frame (bounding box) and the adaptation can take place if the frame touches or passes over one of the boundaries. The adaptation can take place only if the object 110 was additionally determined as the most relevant.

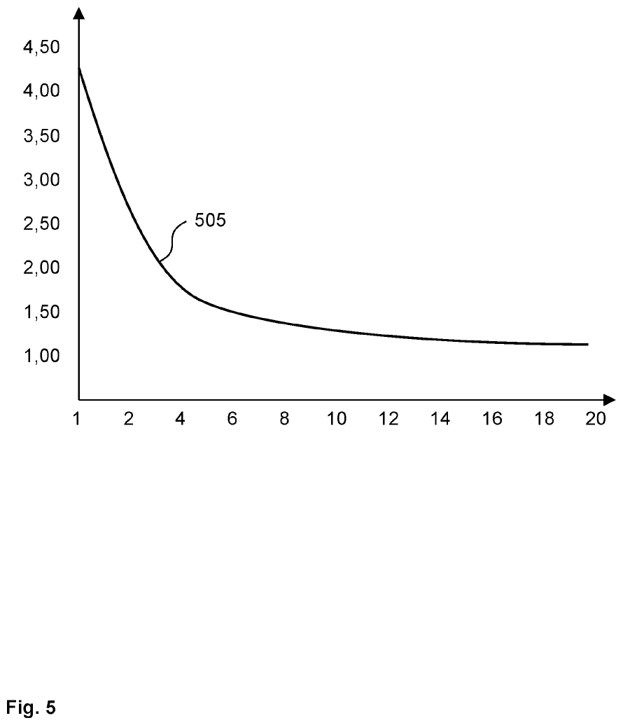

FIG. 5 shows a schematic and exemplary relationship between a distance and a scaling factor. A distance between the vehicle 105 and the object 110 is shown in the horizontal direction. A scaling factor is plotted in the vertical direction, using which the second partial image has to be adapted in order to be scaled the same as the first partial image in the area of the determined distance.

In one or more embodiments, the second partial image has to be scaled by a factor of approximately 4.5 if the object 110 to be displayed is located at a distance of approximately 1 m. An image angle of the first sensor 115 is therefore to be greater by at least this factor than an image angle of the second sensor 120. For example, if the image angle of the second sensor 120 is approximately 34°, the image angle of the first sensor 115 is to be at least approximately 34×4.5=153°. These observations apply to the vertical image angle; similar considerations can be made for the horizontal image angle.

### LIST OF REFERENCE SIGNS

100 device
105 vehicle
110 further vehicle
115 first camera
120 second camera
125 distance sensor
130 processing device
135 monitor
140 orientation sensor
200 method
205 create first partial image
210 create second partial image
215 recognize objects
220 select object
225 determine distance to object
230 adapt second partial image
235 merge partial images
240 hide area
245 display overall image
305 overall image
310 first section
315 second section
320 joining line
325 third section
330 fourth section
405 transition area

1-15. (canceled)

16. A method for merging partial images of surroundings of a vehicle to form an overall image, wherein the method comprises:
acquiring a first partial image in a first area of the surroundings, wherein the first area is located laterally behind the vehicle;
acquiring a second partial image in a second area of the surroundings, wherein the second area is located behind the vehicle;
acquiring an object, at least one section of which is located in one of the areas;
determining a distance of the object from the vehicle;
adapting the second partial image depending on the distance; and
merging the partial images to form the overall image.

17. The method according to claim 16, wherein the overall image comprises a first section, which is taken from the first partial image and represents an area of the surroundings outside the vehicle; and a second section, which is taken from the second partial image and represents an area of the surroundings located behind the vehicle.

18. The method according to claim 17, wherein a joining line, which delimits the first section on the overall image, is permanently predetermined based on perspectives and imaging parameters of the partial images.

19. The method according to claim 16, wherein the overall image comprises a third section, which conceals an area located between the vehicle and the object, if a further object is located in this area.

20. The method according to claim 19, wherein the third section is taken from the first partial image and shows the vehicle.

21. The method according to claim 16, wherein adaptations of the second partial image are predetermined for multiple predetermined distances between the vehicle and the object.

22. The method according to claim 21, wherein an adaptation is interpolated with respect to a first predetermined adaptation, an assigned distance of which is less than one of the predetermined distances, and a second predetermined adaptation, the assigned distance of which is greater than the determined distance and is applied to the second partial image.

23. The method according to claim 16, wherein, of multiple objects in the surroundings of the vehicle, one is selected, the distance of which to the vehicle is least.

24. The method according to claim 16, wherein, of multiple objects in the surroundings of the vehicle, one is selected, an expected time of which until reaching the vehicle is least.

25. The method according to claim 16, wherein, of multiple objects in the surroundings of the vehicle, one is selected, which is most sensitive with respect to a collision with the vehicle.

26. The method according to claim 16, wherein a first sensor for providing the first partial image is calibrated based on a feature of the vehicle, which can be optically acquired, in the first area.

27. The method according to claim 16, wherein a second sensor for providing the second partial image is calibrated by an orientation sensor.

28. A device for merging partial images of surroundings of a vehicle to form an overall image, wherein the device comprises:
a first sensor for acquiring a first partial image in a first area of the surroundings, wherein the first area is located laterally behind the vehicle;
a second sensor for acquiring a second partial image in a second area of the surroundings, wherein the second area is located behind the vehicle;
a third sensor for determining a distance of an object, at least one section of which is located in one of the areas, from the vehicle; and
a processing device for adapting the second partial image depending on the distance; and for merging the partial images to form the overall image.

29. The device according to claim 28, wherein an orientation sensor is provided for determining an orientation of the second sensor in relation to the surroundings.

30. A vehicle comprising:
a device for merging partial images of surroundings of the vehicle to form an overall image, wherein the device comprises:
a first sensor for acquiring a first partial image in a first area of the surroundings, wherein the first area is located laterally behind the vehicle;
a second sensor for acquiring a second partial image in a second area of the surroundings, wherein the second area is located behind the vehicle;
a third sensor for determining a distance of an object, at least one section of which is located in one of the areas, from the vehicle; and
a processing device for adapting the second partial image depending on the distance; and for merging the partial images to form the overall image.

31. The vehicle according to claim 30, wherein the device further comprises an orientation sensor configured to determine an orientation of the second sensor in relation to the surroundings.
